(19) United States
(12) Patent Application Publication
(10) Pub. No.: US 2003/0027928 A1
(43) Pub. Date: Feb. 6, 2003

(54) POLYCARBONATE RESIN COMPOSITION

(76) Inventors: MASAYA OKAMOTO, ICHIHARA-SHI (JP); AKIO NODERA, ICHIHARA-SHI (JP); MASAHIRO KITAYAMA, ICHIHARA-SHI (JP)

Correspondence Address: OBLON SPIVAK MCCLELLAND MAIER, AND NEUSTADT PC, FOURTH FLOOR, 1755 JEFFERSON DAVIS HIGHWAY, ARLINGTON, VA, 22202

(21) Appl. No.: 09/457,744

(22) Filed: Dec. 10, 1999

(30) Foreign Application Priority Data
Jun. 23, 1999 (JP) 11-176305
Jul. 6, 1999 (JP) 11-191187
Jul. 6, 1999 (JP) 11-191188

(51) Int. Cl. C08F 8/00

(52) U.S. Cl. 525/101

(57) ABSTRACT

Provided are polycarbonate resin compositions as described in (i) to (iii) below.

(i) A polycarbonate resin composition wherein 100 parts by weight of an aromatic polycarbonate resin containing (A-1) an aromatic polycarbonate-polyorganosiloxane copolymer and (B-1) a copolyester carbonate having an aliphatic segment are blended with (C) from 0.05 to 1 part by weight of polytetrafluoroethylene having a number average molecular weight of at least 500,000 and having a fibril formability. (ii) A polycarbonate resin composition wherein 100 parts by weight of an aromatic polycarbonate resin containing (A-2) an aromatic polycarbonate-polyorganosiloxane copolymer having a terminal group represented by formula (1)

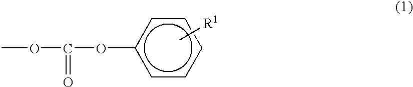

wherein

R¹ represents an alkyl group having from 10 to 20 carbon atoms are blended with (C) from 0.05 to 1 part by weight of polytetrafluoroethylene having a number average molecular weight of at least 500,000 and having a fibril formability.

(iii) A polycarbonate resin composition wherein 100 parts by weight of an aromatic polycarbonate containing (A-3) an aromatic polycarbonate-polyorganosiloxane copolymer having a terminal group represented by formula (2)

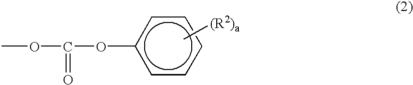

wherein

R² represents an alkyl group having from 1 to 9 carbon atoms, an aryl group having from 6 to 20 carbon atoms or a halogen atom, and

a is an integer of from 0 to 5

and (B-2) an aromatic polycarbonate having a terminal group represented by formula (1)

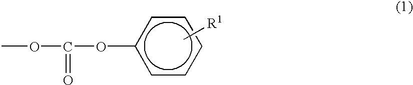

wherein

R¹ represents an alkyl group having from 10 to 20 carbon atoms

are blended with (C) from 0.05 to 1 part by weight of polytetrafluoroethylene having a number average molecular weight of at least 500,000 and having a fibril formability.

### TECHNICAL FIELD

The present invention relates to a polycarbonate resin composition. More specifically, it relates to a polycarbonate resin composition excellent in fluidity, impact resistance and flame retardance.

### DESCRIPTION OF THE RELATED ART

Polycarbonate resins are excellent in mechanical strengths (especially impact resistance), electrical characteristics and transparency, and have been used as engineering plastics, extensively in various fields of an office automation equipment typified by a copier and a printer, electrical and electronic appliances and automobiles. Among these fields, there are the fields requiring a flame retardance, mainly the fields of an office automation equipment and electrical and electronic appliances.

Among various thermoplastic resins, polycarbonate resins have a high oxygen index and a self-extinguishing property. However, the level of the flame retardance required for the fields of an office automation equipment and electrical and electronic appliances is generally as high as V-0 level according to UL94 standard. For imparting this level of the flame retardance, the addition of a flame retardant and a flame retardant aid is deemed to be required.

However, the use of such additives results in decreasing an impact resistance or a heat resistance. In order to solve this problem, a composition containing a polycarbonate resin, a polycarbonate-polyorganosiloxane copolymer and a polytetrafluoroethylene is disclosed (JP-A-8-81620). On the other hand, a flame-retardant material which can be molded into a large-sized thin product such as a housing of a copier or a printer and which is excellent in fluidity has been recently required. Although the fluidity can be improved by decreasing the molecular weight of the polycarbonate-polyorganosiloxane copolymer in the technology disclosed in the above-mentioned document, it involves a problem of decreasing the impact resistance. Further, although the fluidity can be improved by decreasing the molecular weight of the polycarbonate resin, there is a problem that the flame retardance and the impact resistance are decreased.

### SUMMARY OF THE INVENTION

Under these circumstances, the invention is to provide a polycarbonate resin composition excellent in fluidity, impact resistance and flame retardance.

The present inventors have assiduously conducted investigations, and have consequently found that a polycarbonate resin composition in which an aromatic polycarbonate resin containing an aromatic polycarbonate-polyorganosiloxane copolymer and a copolyester carbonate having an aliphatic segment is blended with specific polytetrafluoroethylene can be adapted to the object of the invention.

The inventors have further found that a polycarbonate resin composition in which an aromatic polycarbonate resin containing an aromatic polycarbonate-polyorganosiloxane copolymer having a specific terminal group is blended with specific polytetrafluoroethylene can be adapted to the object of the invention.

The inventors have still further found that an aromatic polycarbonate resin in which an aromatic polycarbonate resin containing an aromatic polycarbonate-polyorganosiloxane copolymer having a general terminal group and an aromatic polycarbonate having a specific terminal group is blended with specific polytetrafluoroethylene can be adapted to the object of the invention.

The inventors have come to complete the invention based on these findings.

That is, in the first mode of the invention, there are provided a polycarbonate resin composition wherein 100 parts by weight of an aromatic polycarbonate resin containing (A-1) an aromatic polycarbonate-polyorganosiloxane copolymer and (B-1) a copolyester carbonate having an aliphatic segment are blended with (C) from 0.05 to 1 part by weight of polytetrafluoroethylene having a number average molecular weight of at least 500,000 and having a fibril formability, and a housing of an office automation equipment formed by using this composition.

Further, in the second mode of the invention, there are provided a polycarbonate resin composition wherein 100 parts by weight of an aromatic polycarbonate resin containing (A-2) an aromatic polycarbonate-polyorganosiloxane copolymer having a terminal group represented by formula (1)

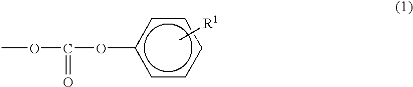

wherein

R¹ represents an alkyl group having from 10 to 20 carbon atoms

are blended with (C) from 0.05 to 1 part by weight of polytetrafluoroethylene having a number average molecular weight of at least 500,000 and having a fibril formability, and a housing of an office automation equipment formed by using this composition.

Furthermore, in the third mode of the invention, there are provided a polycarbonate resin composition wherein 100 parts by weight of an aromatic polycarbonate resin containing (A-3) an aromatic polycarbonate-polyorganosiloxane copolymer having a terminal group represented by formula (2)

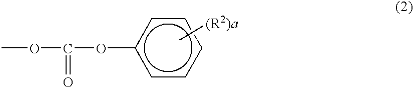

wherein

R² represents an alkyl group having from 1 to 9 carbon atoms, an aryl group having from 6 to 20 carbon atoms or a halogen atom, and

a is an integer of from 0 to 5

and (B-2) an aromatic polycarbonate having a terminal group represented by formula (1)

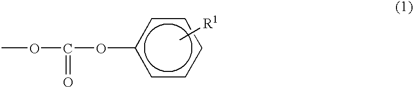

wherein

R¹ represents an alkyl group having from 10 to 20 carbon atoms

are blended with (C) from 0.05 to 1 part by weight of polytetrafluoroethylene having a number average molecular weight of 500,000 and having a fibril formability, and a housing of an office automation equipment formed by using this composition.

### DETAILED DESCRIPTION OF THE INVENTION

First, the aromatic polycarbonate-polyorganosiloxane copolymer (hereinafter abbreviated as “PC-PDMS copolymer A”) as (A-1) component constituting the resin composition in the first mode of the invention is a copolymer comprising an aromatic polycarbonate moiety and a polyorganosiloxane moiety. For example, copolymers disclosed in JP-A-50-29695, JP-A-3-292359, JP-A-4-202465, JP-A-8-81620, JP-A-8-302178 and JP-A-10-7897 can be mentioned. Preferable is a copolymer having in a molecule an aromatic polycarbonate moiety having a recurring unit represented by the following structural formula (3) and a polyorganosiloxane moiety having a structural unit represented by the following structural formula (4) can be mentioned.

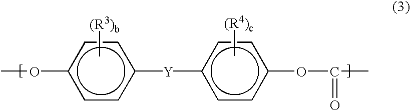

wherein

R³ and R⁴ which may be the same or different each represent an alkyl group having form 1 to 6 carbon atoms, or a phenyl group.

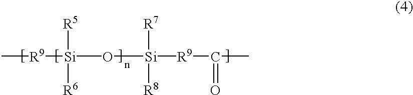

wherein

R⁵ to R⁸ which may be the same or different each represent an alkyl group having from 1 to 6 carbon atoms, or a phenyl group, preferably a methyl group,

R⁹ represents an aliphatic or aromatic organic residue, preferably an o-allylphenol residue, a p-hydroxystyrene residue, or an eugenol residue,

Y represents a single bond, an alkylene group having from 1 to 20 carbon atoms, an alkylidene group having from 1 to 20 carbon atoms, a cycloalkylene group having from 5 to 20 carbon atoms, a cycloalkylidene group having from 5 to 20 carbon atoms, or a —SO₂—, —SO—, —S—, —O—or —CO— bond, preferably an isopropylidene group,

b and c are each an integer of from 0 to 4, preferably 0, and

n is an integer of from 1 to 500, preferably from 5 to 100.

This PC-PDMS copolymer A can be produced by, for example, dissolving an aromatic polycarbonate oligomer (hereinafter abbreviated as “PC oligomer”) constituting an aromatic polycarbonate moiety which is formed previously and a polyorganosiloxane (reactive PDMS) having a reactive group such as an o-allylphenol residue, a p-hydroxystyrene residue or an eugenol residue in the end, which constitutes a polyorganosiloxane moiety in a solvent such as methylene chloride, chlorobenzene or chloroform, adding an alkali hydroxide aqueous solution of a dihydric phenol to the solution, and conducting an interfacial polycondensation reaction in the presence of an end capping agent using a tertiary amine (triethylamine) or a quaternary ammonium salt (trimethylbenzylammonium chloride) as a catalyst.

As the end capping agent, compounds which are ordinarily used in the production of a polycarbonate are available, and various compounds can be used. Specific examples thereof can include monohydric phenols such as phenol, p-cresol, p-tert-butylphenol, p-tert-octylphenol, p-cumylphenol, p-nonylphenol, p-tert-amylphenol, bromophenol, tribromophenol, and pentabromophenol. Of these, halogen-free compounds are preferable in view of the environmental problem.

PC oligomer used to produce PC-PDMS copolymer A can easily be produced by, for example, reacting a dihydric phenol represented by formula (5)

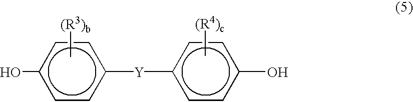

wherein R³, R⁴, Y, b and c are as defined above with a carbonate precursor such as phosgene or a carbonate ester compound in a solvent such as methylene chloride.

That is, for example, it is produced by the reaction of a dihydric phenol and a carbonate precursor such as phosgene in the presence of a solvent such as methylene chloride, or the transesterification reaction of a dihydric phenol and a carbonate precursor such as diphenyl carbonate.

Preferable examples of the dihydric phenol represented by formula (5) include 4,4′-dihydroxydiphenyl; bis(4-hydroxyphenyl)alkanes such as 1,1-bis(4-hydroxyphenyl)methane, 1,1-bis(4-hydroxyphenyl)ethane, and 2,2-bis(4-hydroxyphenyl)propane; bis(4-hydroxyphenyl)cycloalkanes; bis(4-hydroxyphenyl) oxide; bis(4-hydroxyphenyl) sulfide; bis(4-hydroxyphenyl)sulfone; bis(4-hydroxyphenyl) sulfoxide; bis(4-hydroxyphenyl) ether; and bis(4-hydroxyphenyl)ketones. Of these, 2,2-bis(4-hydroxyphenyl)propane (namely bisphenol A) is preferable. These dihydric phenols may be used either singly or in combination.

Further, examples of the carbonate ester compound include diaryl carbonates such as diphenyl carbonate, and dialkyl carbonates such as dimethyl carbonate and diethyl carbonate.

In the invention, PC oligomer used to produce PC-PDMS copolymer A may be a homopolymer obtained by using one type of the dihydric phenols or a copolymer obtained by using two or more types thereof. Further, it may be a thermoplastic random branched polycarbonate obtained by using a polyfunctional aromatic compound in combination with the dihydric phenol. In this case, examples of the polyfunctional aromatic compound (branching agent) can include 1,1,1-tris(4-hydroxyphenyl)ethane, α,α′,α″-tris(4-hydroxyphenyl)-1,3,5-tri-iso-propylbenzene, 1-[α-methyl-α-(4′-hydroxyphenyl)ethyl]-4-[α′,α′-bis(4″-hydroxyphenyl)ethyl]benzene, phloroglucin, trimellitic acid, and isatinbis (o-cresol).

(A-1) component can be produced in the foregoing manner. However, generally, an aromatic polycarbonate resin is formed as a by-product. An aromatic polycarbonate resin containing (A-1) component is produced, and the overall viscosity average molecular weight is preferably between 10,000 and 40,000, more preferably between 12,000 and 30,000. Further, the proportion of the polyorganosiloxane is preferably between 0.5 and 10% by weight based on the overall aromatic polycarbonate resin containing (A-1) component.

Next, (A-2) component constituting the resin composition in the second mode of the invention is described. (A-2) component is an aromatic polycarbonate-polyorganosiloxane copolymer (hereinafter abbreviated as “PC-PDMC copolymer B”) having a terminal group represented by formula (1).

In formula (1), R¹ is an alkyl group having from 10 to 20 carbon atoms which may be linear or branched. Further, the larger number of carbon atoms in this range is preferable.

Specific examples of the alkyl group include decyl, undecyl, dodecyl, tridecyl, tetradecyl, pentadecyl, hexadecyl, heptadecyl, octadecyl, nonadecyl and eicosyl groups. Further, the binding position may be the p-position, the m-position or the o-position, and the p-position is preferable.

PC-PDMS copolymer B is a copolymer comprising an aromatic polycarbonate moiety and a polysiloxane moiety. With respect to the structures other than the terminal group, for example, the copolymers disclosed in the documents employed in the description of PC-PDMS copolymer A can be mentioned. Preferable is the copolymer having in the molecule the aromatic polycarbonate moiety composed of the recurring unit represented by structural formula (3) and the polyorganosiloxane moiety composed of the recurring unit represented by structural formula (4) as used in the description of PC-PDMS copolymer A.

This PC-PDMS copolymer B can be produced by, for example, dissolving an aromatic polycarbonate oligomer (PC oligomer) constituting an aromatic polycarbonate moiety previously produced and a polyorganosiloxane (reactive PDMS) having a reactive group such as an o-allylphenol residue, a p-hydroxystyrene residue or an eugenol residue in the end which constitutes a polyorganosiloxane moiety in a solvent such as methylene chloride, chlorobenzene or chloroform, adding thereto an alkali hydroxide aqueous solution of a dihydric phenol, and conducting an interfacial polycondensation reaction in the presence of an end capping agent composed of a phenol compound represented by formula (6)

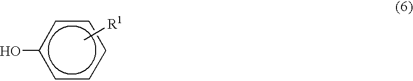

wherein R¹ is as defined above using a tertiary amine (triethylamine) or a quaternary ammonium salt (trimethylbenzylammonium chloride) as a catalyst.

In formula (6), the description of R¹ is the same as the foregoing description.

PC oligomer used to produce PC-PDMS copolymer B can easily be produced by, for example, reacting a dihydric phenol represented by formula (5) with a carbonate precursor such as phosgene or a carbonate ester compound in a solvent such as methylene chloride.

That is, it is produced by, for example, the reaction of a dihydric phenol and a carbonate precursor such as phosgene in a solvent such as methylene chloride, or the transesterification reaction of a dihydric phenol and a carbonate precursor such as diphenyl carbonate.

Further, examples of the carbonate ester compound can include diaryl carbonates such as diphenyl carbonate; and dialkyl carbonates such as dimethyl carbonate and diethyl carbonate.

In the invention, PC oligomer used to produce PC-PDMS copolymer B may be a homopolymer obtained by using one type of the dihydric phenols or a copolymer obtained by using two or more types thereof. Further, it may be a thermoplastic random branched polycarbonate obtained by using a polyfunctional aromatic compound in combination with the dihydric phenol. In this case, as the polyfunctional aromatic compound (branching agent), the compounds mentioned in the description of PC-PDMS copolymer A can be used.

(A-2) component can be produced in the foregoing manner. However, generally, an aromatic polycarbonate having a terminal group represented by formula (1) (hereinafter abbreviated as “terminal-modified aromatic polycarbonate B”) is formed as a by-product. An aromatic polycarbonate resin containing (A-2) component is produced. In this case, the overall viscosity average molecular weight is preferably between 10,000 and 40,000, more preferably between 12,000 and 30,000.

Further, the proportion of the polyorganosiloxane is preferably between 0.5 and 10% by weight based on the overall aromatic polycarbonate resin containing (A-2) component.

The polymer produced by the foregoing method has substantially the terminal group(s) represented by formula (1) in one or both ends of the molecule.

In the invention, the aromatic polycarbonate resin containing (A-2) component formed by the foregoing method may be used as such or may further contain a general aromatic polycarbonate resin or terminal-modified aromatic polycarbonate B formed separately. In this case, the sum of the amount of PC-PDMS copolymer B as (A-2) component and the amount of terminal-modified aromatic polycarbonate B is preferably at least 10% by weight, more preferably at least 30% by weight, especially preferably at least 50% by weight based on the overall polycarbonate resin containing component (A-2). When it is less than 10% by weight, the fluidity of the composition in the invention is sometimes not improved. Further, the viscosity average molecular weight of the aromatic polycarbonate resin to be newly blended is preferably between 10,000 and 40,000, more preferably between 12,000 and 30,000.

The general aromatic polycarbonate resin or terminal-modified aromatic polycarbonate B produced separately is not particularly limited. It can easily be produced by the reaction of a dihydric phenol and phosgene or a carbonate ester compound.

That is, it is produced by, for example, the reaction of a dihydric phenol and a carbonate precursor such as phosgene or the transesterification reaction of a dihydric phenol and a carbonate precursor such as diphenyl carbonate in the presence of a catalyst such as triethylamine and an end capping agent.

The dihydric phenol here referred to may be the same as, or different from, the compound represented by formula (5) which is used to produce (A-2) component. Further, it may be a homopolymer obtained by using one type of the dihydric phenols or a copolymer obtained by using two or more types thereof. Still further, it may be a thermoplastic random branched polycarbonate which is obtained by using a polyfunctional aromatic compound in combination with the dihydric phenol.

Examples of the carbonate ester compound can include diaryl carbonates such as diphenyl carbonate; and dialkyl carbonates such as dimethyl carbonate and diethyl carbonate.

As the end capping agent, the compounds listed in the description of the method of producing PC-PDMS copolymer A can be mentioned in case of a general aromatic polycarbonate resin. Of these, halogen-free compounds are preferable in view of the environmental problem. In case of terminal-modified aromatic polycarbonate B, the phenol compound represented by formula (6) is used.

The viscosity average molecular weight of the overall aromatic polycarbonate resin containing (A-2) component is preferably between 10, 000 and 40, 000, more preferably between 12,000 and 30,000, especially preferably between 14,000 and 26,000. When the molecular weight is too low, the mechanical strengths of the resin composition in the invention are sometimes poor. When the molecular weight is too high, the fluidity of the resin composition in the invention is sometimes poor.

The amount of the polyorganosiloxane is preferably between 0.1 and 2.0% by weight based on the overall aromatic polycarbonate resin containing (A-2) component in view of the flame retardance of the resin composition in the invention. It is further preferably between 0.2 and 1.5% by weight, especially preferably between 0.5 and 1.3% by weight. (A-3) component constituting the resin composition in the third mode of the invention is an aromatic polycarbonate-polyorganosiloxane copolymer having a terminal group represented by formula (2) (hereinafter abbreviated as “PC-PDMS copolymer C”). For example, copolymers disclosed in JP-A-50-29695, JP-A-3-292359, JP-A-4-202465, JP-A-8-81620, JP-A-8-302178 and JP-A-10-7897 can be mentioned. Preferable is a copolymer having in a molecule an aromatic polycarbonate moiety represented by structural formula (3) and a polyorganosiloxane moiety composed of a recurring unit represented by structural formula (4).

This PC-PDMS copolymer C can be produced by, for example, dissolving an aromatic polycarbonate oligomer (hereinafter abbreviated as “PC oligomer”) constituting an aromatic polycarbonate moiety previously produced and a polyorganosiloxane (reactive PDMS) having a reactive group such as an o-allylphenol residue, a p-hydroxystyrene residue or an eugenol residue in the end which constitutes a polyorganosiloxane moiety in a solvent such as methylene chloride, chlorobenzene or chloroform, adding thereto an alkali hydroxide aqueous solution of a dihydric phenol, and conducting an interfacial polycondensation reaction in the presence of an end capping agent composed of a phenol compound represented by formula (7)

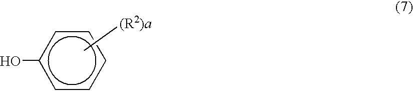

wherein R² and a are as defined above using a tertiary amine (triethylamine) or a quanternary ammonium salt (trimethylbenzylammonium chliride) as a catalyst.

As the end capping agent, for example, the compounds listed in the description of PC-PDMS copolymer A can specifically be mentioned. Of these, the halogen-free compounds are preferable in view of the environmental problem.

PC oligomer used to produce PC-PDMS copolymer C can easily be produced by, for example, reacting a dihydric phenol represented by formula (5) with a carbonate precursor such as phosgene or a carbonate ester compound in a solvent such as methylene chloride.

In the invention, PC oligomer used to produce PC-PDMS copolymer C may be a homopolymer obtained by using one type of the dihydric phenols or a copolymer obtained by using two or more types thereof. Further, it may be a thermoplastic random branched polycarbonate obtained by using a polyfunctional aromatic compound in combination with the dihydric phenol. In this case, as the polyfunctional aromatic compound (branching agent), the compounds mentioned in the description of PC-PDMS copolymer A can be used.

(A-3) component can be produced in the foregoing manner. However, generally, an aromatic polycarbonate is formed as a by-product. An aromatic polycarbonate resin containing (A-3) component is produced. The overall viscosity average molecular weight is preferably between 10, 000 and 40, 000, more preferably between 12,000 and 30,000. Further, the proportion of the polyorganosiloxane is preferably between 0.5 and 10% by weight based on the overall polycarbonate resin containing (A-3) component. The polymer produced by the foregoing method has substantially the terminal group(s) represented by formula (2) in one or both ends of the molecule.

Next, the copolyester carbonate having the aliphatic segment (hereinafter abbreviated as “BPA-PMDC copolymer”) as (B-1) component constituting the first mode of the invention is described.

This copolymer comprises, for example, an aromatic polycarbonate moiety and a polyester moiety derived from a dihydric phenol and polymethylenedicarboxylic acid. Preferable is a copolymer having in a molecule an aromatic polycarbonate moiety composed of a recurring unit represented by the following structural formula (8) and a polyester moiety composed of a recurring unit represented by the following structural formula (9).

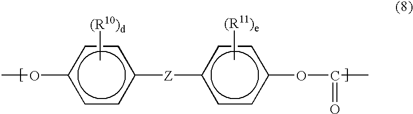

wherein R¹⁰ and R¹¹ may be the same or different, and each represents an alkyl group having from 1 to 6 carbon atoms or a phenyl group.

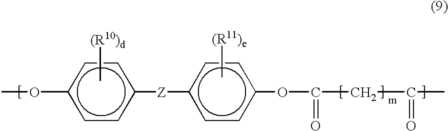

wherein

Z represents a single bond, an alkylene group having from 1 to 20 carbon atoms, an alkylidene group having from 1 to 20 carbon atoms, a cycloalkylene group having from 5 to 20 carbon atoms, a cycloalkylidene group having from 5 to 20 carbon atoms, or a —SO₂—, —SO—, —S—, —O— or —CO— bond, preferably an isopropylidene group,

d and e are each an integer of from 0 to 4, preferably 0, and

m is an integer of from 5 to 20, preferably from 8 to 12.

The viscosity average molecular weight of BPA-PMDC copolymer as (B-1) component is preferably between 10,000 and 40,000, more preferably between 12,000 and 30,000.

This BPA-PMDC copolymer can be produced by, for example, dissolving a polycarbonate oligomer (hereinafter abbreviated as “PC oligomer”) constituting an aromatic polycarbonate moiety previously produced and a polymethylenedicarboxylic acid in a solvent such as methylene chloride, chlorobenzene or chloroform, adding thereto an alkali hydroxide aqueous solution of a dihydric phenol, and conducting an interfacial polycondensation reaction in the presence of an end capping agent using a tertiary amine (triethylamine) or a quaternary ammonium salt (trimethylbenzylammonium chloride) as a catalyst. PC oligomer is produced in the same manner as PC oligomer used in the production of (A-1) component using a dihydric phenol represented by formula (10)

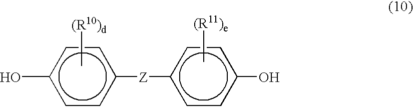

wherein R¹⁰, R¹¹, Z, d and e are as defined above.

As the polymethylenedicarboxylic acid, a dicarboxylic acid having a polymethylene group with from 5 to 20 carbon atoms is used. Preferable is a dicarboxylic acid having a polymethylene group with from 8 to 12 carbon atoms.

(B-1) component can be produced in the foregoing manner. However, generally, an aromatic polycarbonate resin is formed as a by-product. An aromatic polycarbonate resin containing (B-1) component is produced, and the overall viscosity average molecular weight is preferably between 10,000 and 40, 000, more preferably between 12,000 and 30,000. Further, the amount of the unit derived from the polymethylenedicarboxylic acid in the aromatic polycarbonate resin containing (B-1) component is between 1 and 25 mol % based on the sum of the unit derived from the dihydric phenol and the unit derived from the polymethylenedicarboxylic acid.

(B-2) component constituting the resin composition in the third mode of the invention is an aromatic polycarbonate having a terminal group represented by formula (1) (hereinafter abbreviated as “terminal-modified polycarbonate C”). The viscosity average molecular weight thereof is preferably between 10,000 and 40,000, more preferably between 12,000 and 30,000.

R¹ of formula (1) is the same as that in (A-2) component.

This terminal-modified polycarbonate C can easily be produced by the reaction of a dihydric phenol with phosgene or a carbonate ester compound.

That is, it is produced by, for example, the reaction of a dihydric phenol with a carbonate precursor such as phosgene or the transesterification reaction of a dihydric phenol with a carbonate precursor such as diphenyl carbonate in the presence of a catalyst such as triethylamine and a specific end capping agent.

The dihydric phenol here referred to may be the same as, or different from, the compound represented by formula (5). Further, it may be a homopolymer obtained by using one type of the dihydric phenols or a copolymer obtained by using two or more types thereof. Still further, it may be a thermoplastic random branched polycarbonate obtained by using a polyfunctional aromatic compound in combination with the dihydric phenol.

Examples of the carbonate ester compound can include diaryl carbonates such as diphenyl carbonate; and dialkyl carbonates such as dimethyl carbonate and diethyl carbonate.

As the end capping agent, the phenol compound by which to form the terminal group represented by formula (1) is used. That is, it is a phenol compound represented by formula (6) wherein R¹ is as defined above.

The aromatic polycarbonate produced by the foregoing method has substantially terminal group(s) represented by formula (1) in one or both ends of the molecule.

The aromatic polycarbonate resin containing (A-1) component and (B-1) component is described below. The aromatic polycarbonate resin containing (A-1) component and (B-1) component is obtained by blending the aromatic polycarbonate resin containing (A-1) component with the aromatic polycarbonate resin containing (B-1) component, and it may further be blended with a general aromatic polycarbonate resin. In this case, the viscosity average molecular weight of the aromatic polycarbonate resin to be newly blended is preferably between 10,000 and 40,000, more preferably between 12,000 and 30,000.

The general aromatic polycarbonate resin is the same as the general aromatic polycarbonate resin in the aromatic polycarbonate resin containing (A-2) component.

The viscosity average molecular weight of the overall aromatic polycarbonate resin containing (A-1) component and (B-1) component is preferably between 10,000 and 40,000, more preferably between 12,000 and 30,000, especially preferably between 14,000 and 26,000. When the molecular weight is too low, the resin composition of the invention is sometimes poor in mechanical strengths. When the molecular weight is too high, the resin composition of the invention is sometimes poor in fluidity.

The content of the polyorganosiloxane in (A-1) component is between 0.1 and 2.0% by weight based on the overall aromatic polycarbonate resin containing (A-1) component and (B-1) component in view of the flame retardance of the resin composition in the invention. It is further preferably between 0.2 and 1.5% by weight, especially preferably between 0.5 and 1.3% by weight.

Further, the proportion of the unit derived from the polymethylenedicarboxylic acid in (B-1) component is preferably between 1 and 15 mol %, more preferably between 2 and 12 mol %, especially preferably between 3 and 10 mol % based on the sum of the unit derived from the main monomer (dihydric phenol) and the unit derived from the polymethylenedicarboxylic acid in the overall aromatic polycarbonate resin containing (A-1) component and (B-1) component. When the proportion of the unit derived from the polymethylenedicarboxylic acid is too low, the resin composition of the invention is sometimes not improved in the fluidity. When it is too high, the heat resistance of the resin composition of the invention is sometimes decreased.

The aromatic polycarbonate resin containing (A-3) component and (B-2) component is described below. The aromatic polycarbonate resin containing (A-3) component and (B-2) component can be obtained by blending the aromatic polycarbonate resin containing (A-3) component with (B-2) component. It may further be blended with a general aromatic polycarbonate. In this case, the viscosity average molecular weight of the aromatic polycarbonate resin to be newly blended is preferably between 10,000 and 40,000, more preferably between 12,000 and 30,000. The aromatic polycarbonate resin can be produced in the same manner as (B-2) component using the phenyl compound of formula (7) generally used as an end capping agent. At this time, the dihydric phenol may be the same as, or different from, that of formula (5) used in the production of (A-3) component and that used in the production of (B-2) component.

The viscosity average molecular weight of the overall aromatic polycarbonate resin containing (A-3) component and (B-2) component is preferably between 10,000 and 40,000, more preferably between 12,000 and 30,000, especially preferably between 14,000 and 26,000. When the molecular weight is too low, the resin composition of the invention is sometimes poor in mechanical strengths. When the molecular weight is too high, the resin composition of the invention is sometimes poor in fluidity.

The content of the polyorganosiloxane in (A-3) component is between 0.1 and 2.0% by weight based on the overall aromatic polycarbonate resin containing (A-3) component and (B-2) component in view of the flame retardance of the resin composition in the invention. It is further preferably between 0.2 and 1.5% by weight, especially preferably between 0.5 and 1.3% by weight.

Further, the amount of the aromatic polycarbonate as (B-2) component is preferably at least 10% by weight, more preferably between 30 and 90% by weight, especially preferably between 40 and 80% by weight based on the overall aromatic polycarbonate resin containing (2%-3) component and (B-2) component. When it is less than 10% by weight, the fluidity of the composition of the invention is sometimes not improved.

Polytetrafluoroethylene (hereinafter abbreviated as “PTFE”) having a number average molecular weight of at least 500,000 and having a fibril formability as (C) component constituting the invention can provide an effect of preventing melt dropping and impart a high flame retardance. The number average molecular weight thereof has to be at least 500,000, and it is preferably between 500,000 and 10,000,000, more preferably between 1,000,000 and 10,000,000.

The amount of (C) component is between 0.05 and 1.0 part by weight, preferably between 0.1 and 0.5 parts by weight per 100 parts by weight of the aromatic polycarbonate resin containing (A-1) component and (B-1) component, per 100 parts by weight of the aromatic polycarbonate resin containing (A-2) component or per 100 parts by weight of the aromatic polycarbonate resin containing (A-3) component and (B-2) component. When this amount exceeds 1.0 part by weight, it has not only an adverse effect on an impact strength and an appearance of a molding product, but also is a jetted strand waved in the kneading and the extrusion, so that stable pellets are not produced. Thus, it is undesirable. Further, when it is less than 0.05 parts by weight, no satisfactory effect of preventing melt dropping is provided. The desirable range gives a preferable effect of preventing melt dropping, and an excellent flame retardance is provided.

PTFE having a fibril formability as (C) component of the resin composition in the invention is not particularly limited. Specific examples thereof can include Teflon 6-J (trade name for a product of Mitsui•du Pont Fluorochemical), Polyflon D-1 and Polyflon F-103 (trade names for products of Daikin Kogyo Co., Ltd.), Argoflon F5 (trade name for a product of Montefluos), and Polyflon MPA FA-100 (trade name for a product of Daikin Kogyo Co., Ltd.). These PTFE's may be used either singly or in combination.

PTFE having the fibril formability can be obtained by, for example, polymerizing tetrafluoroethylene in an aqueous solvent in the presence of sodium, potassium or ammonium peroxydisulfide at a pressure of from 1 to 100 psi and a temperature of from 0 to 200° C., preferably from 20 to 100° C.

The resin composition of the invention can further contain, as required, various inorganic fillers, additives, other synthetic resins and elastomers unless the object of the invention is impaired (these are hereinafter abbreviated as (D) component).

First, inorganic fillers to be incorporated for imparting mechanical strengths, a durability or a fillability of the polycarbonate resin composition can include glass fibers (GF), carbon fibers, glass beads, glass flakes, carbon black, calcium sulfate, calcium carbonate, calcium silicate, titanium oxide, alumina, silica, asbestos, talc, clay, mica and quarts powder. Further, additives can include hindered phenol, phosphorus (phosphite ester, phosphate ester) and amine antioxidants; benzotriazole and benzophenone UV absorbers; lubricants such as aliphatic carboxylate esters, paraffins, silicone oil and polyethylene wax; release agents; antistatic agents; and coloring agents.

Examples of the other synthetic resins can include resins such as polyethylene, polypropylene, polystyrene, an AS resin (acrylonitrile-styrene copolymer), an ABS resin (acrylonitrile-butadiene-styrene copolymer) and polymethyl methacrylate. Further, examples of the elastomers can include an isobutylene-isoprene rubber, a styrene-butadiene rubber, an ethylene-propylene rubber and an acrylic elastomer.

The resin composition of the invention can be obtained by blending the foregoing components and, as required, (D) component, and kneading the same.

The blending and the kneading can be conducted by an ordinary method, for example, a method using a ribbon blender, a drum tumbler, a Henschel mixer, a Banbury mixer, a single screw extruder, a twin-screw extruder, a cokneader, or a multi-screw extruder. The heating temperature in the kneading is usually selected in the range of from 240 to 320° C.

The thus-obtained polycarbonate resin composition is preferably molded into, for example, a housing of an office automation equipment (for example, a copier or a printer) requiring a flame retardance by various known molding methods, such as injection molding, blow molding, extrusion molding, compression molding, calender molding and rotational molding.

### EXAMPLES

The invention is illustrated more specifically with reference to Production Examples, Examples and Comparative Examples. However, the invention is not limited thereto.

### Production Example 1

[Production of PC Oligomer]

Sixty kilograms of bisphenol A were dissolved in 400 liters of a 5% by weight sodium hydroxide aqueous solution to prepare a sodium hydroxide aqueous solution of bisphenol A.

Subsequently, the sodium hydroxide aqueous solution of bisphenol A kept at room temperature and methylene chloride were introduced into a tubular reactor having an inner diameter of 10 mm and a tube length of 10 m through an orifice plate at a flow rate of 138 liters/hr and a flow rate of 69 liters/hr respectively. Phosgene was blown in cocurrently at a flow rate of 10.7 kg/hr, and the reaction was conducted continuously for 3 hours. The tubular reactor used herein consisted of a double tube. Cooling water was passed through a jacket to maintain the temperature of the reaction solution discharged at 25° C. Further, the pH of the solution discharged was adjusted to between 10 and 11.

The thus-obtained reaction solution was allowed to stand still, whereby the aqueous phase was separated, and removed. The methylene chloride phase (220 liters) was collected to obtain PC oligomer (concentration 317 g/liter). The degree of polymerization of PC oligomer obtained here was between 2 and 4, and the concentration of the chloroformate group was 0.7 N.

### Production Example 2-1

[Production of Reactive PDMS-A]

Octamethylcyclotetrasiloxane (1.483 g), 96 g of 1,1,3,3-tetramethyldisiloxane and 35 g of 86% sulfuric acid were mixed, and stirred at room temperature for 17 hours. Thereafter, an oil phase was separated, 25 g of sodium hydrogencarbonate was added, and the mixture was stirred for 1 hour. The reaction mixture was filtered, and then vacuum-distilled at 150° C. and 3 torr to remove a low-boiling product and obtain an oil.

The above-obtained oil (294 g) was added to a mixture of 60 g of 2-allylphenol and 0.0014 g of platinum as a platinum chloride-alcoholate complex at a temperature of 90° C. This mixture was stirred for 3 hours while being maintained at from 90 to 115° C. The reaction mixture was extruded with methylene chloride, and washed three times with 80% aqueous methanol to remove excess 2-allylphenol. The product was dried over anhydrous sodium sulfate, and heated to 115° C. in vacuo to distill off the solvent.

The resulting phenol-terminated PDMS was measured through NMR, and it was identified that the recurring number of the dimethylsilanoxy unit was 30.

### Production Example 2-2

[Production of Reactive PDMS-B]

The procedure of Production Example 2-1 was repeated except that 60 g of 2-allyphenol were replaced with 73.4 g of eugenol in Production Example 2-1.

The resulting phenol-terminated PDMS was measured through NMR, and it was identified that the recurring number of the dimethylsilanoxy unit was 30.

### Production Example 2-3

[Production of Reactive PDMS-C]

The procedure of Production Example 2-1 was repeated except that the amount of 1,1,3,3-tetramethyldisiloxane was changed to 18.1 g.

The resulting phenol-terminated PDMS was measured through NMR, and it was identified that the recurring number of the dimethylsilanoxy unit was 150.

### Production Example 3-1

[Production of PC-PDMS Copolymer A1]

Reactive PDMS-A (138 g) obtained in Production Example 2-1 was dissolved in 2 liters of methylene chloride, and the solution was mixed with 10 liters of PC oligomer obtained in Production Example 1. To this were added a solution of 26 g of sodium hydroxide in 1 liter of water and 5.7 cc of triethylamine. The resulting mixture was reacted at 500 rpm and room temperature for 1 hour while being stirred.

After the completion of the reaction, a solution of 600 g of bisphenol A in 5 liters of a 5.2% by weight sodium hydroxide aqueous solution, 8 liters of methylene chloride and 96 g of p-tert-butylphenol were added to the reaction system, and the mixture was reacted at 500 rpm and room temperature for 2 hours while being stirred.

After the completion of the reaction, 5 liters of methylene chloride were added to the reaction solution. Further, the resulting mixture was water-washed with 5 liters of water, alkali-washed with 5 liters of a 0.03 N sodium hydroxide aqueous solution, acid-washed with 5 liters of 0.1 N hydrochloric acid, and water-washed with 5 liters of water in this order. Finally, methylene chloride was removed to obtain flaky PC-PDMS copolymer Al. PC-PDMS copolymer Al obtained was vacuum-dried at 120° C. for 24 hours. The viscosity average molecular weight was 17,000, and the PDMS content was 3.0% by weight. Incidentally, the viscosity average molecular weight and the PDMS content were measured as follows.

(1) Viscosity Average Molecular Weight (Mv)

The viscosity of a methylene chloride solution kept at 20° C. was measured with an Ubbellohde viscometer, whereby the intrinsic viscosity [η] was found. It was then calculated by the following formula.

[η]=1.23×10⁻⁵ Mv⁰⁸³

(2) PDMS Content

The PDMS content was found on the basis of the intensity ratio of the peak attributed to the methyl group of isopropyl of bisphenol A at 1.7 ppm and the peak attributed to the methyl group of dimethylsiloxane at 0.2 ppm by ^{I}H-NMR.

### Production Example 3-2

[Production of PC-PDMS Copolymer A2]

Chipped PC-PDMS copolymer A2 was obtained in the same manner as in Production Example 3-1 except that 138 g of reactive PDMS-A were replaced with 91 g of PDMS-B and 96 g of p-tert-butylphenol with 136 g of p-cumylphenol respectively in Production Example 3-1. The viscosity average molecular weight was 16,800, and the PDMS content was 2.0% by weight.

### Production Example 3-3

Chipped PC-PDMS copolymer A3 was obtained in the same manner as in Production Example 3-1 except that reactive PDMS-A was replaced with PDMS-C in Production Example 3-1. The viscosity average molecular weight was 17,200, and the PDMS content was 3.0% by weight.

### Production Example 3-4

[Production of PC-PDMS Copolymer B1]

Reactive PDMS-A (46 g) obtained in Production Example 2-1 was dissolved in 2 liters of methylene chloride, and the solution was mixed with 10 liters of PC oligomer obtained in Production Example 1. To this were added a solution of 26 g of sodium hydroxide in 1 liter of water and 5.7 cc of triethylamine. The resulting mixture was reacted at 500 rpm and room temperature for 1 hour while being stirred.

After the completion of the reaction, a solution of 600 g of bisphenol A in 5 liters of a 5.2% by weight sodium hydroxide aqueous solution, 8 liters of methylene chloride and 168 g of p-n-dodecylphenol were added to the reaction system, and the mixture was reacted at 500 rpm and room temperature for 2 hours while being stirred.

After the completion of the reaction, 5 liters of methylene chloride were added to the reaction solution. Further, the resulting mixture was water-washed with 5 liters of water, alkali-washed with 5 liters of a 0.03 N sodium hydroxide aqueous solution, acid-washed with 5 liters of 0.2 N hydrochloric acid, and water-washed twice with 5 liters of water in this order. Finally, methylene chloride was removed to obtain flaky PC-PDMS copolymer B1. PC-PDMS copolymer B1 obtained was vacuum-dried at 120° C. for 24 hours. The viscosity average molecular weight was 17,000, and the PDMS content was 1.0% by weight. Incidentally, the viscosity average molecular weight and the PDMS content were measured as described above.

### Production Example 3-5

[Production of PC-PDMS Copolymer B2]

Flaky PC-PDMS copolymer B2 was obtained in the same manner as in Production Example 3-4 except that 46 g of reactive PDMS-A were replaced with 91 g of reactive PDMS-B in Production Example 3-4. The viscosity average molecular weight was 16,900, and the PDMS content was 2.0% by weight.

### Production Example 3-6

[Production of PC-PDMS Copolymer B3]

Flaky PC-PDMS copolymer B3 was obtained in the same manner as in Production Example 3-4 except that the amount of reactive PDMS-A was changed from 46 g to 138 g in Production Example 3-4. The viscosity average molecular weight was 17,000, and the PDMS content was 3.0% by weight.

### Production Example 3-7

[Production of PC-PDMS Copolymer B4]

Flaky PC-PDMS copolymer B4 was obtained in the same manner as in Production Example 3-4 except that reactive PDMS-A was replaced with reactive PDMS-B in Production Example 3-4. The viscosity average molecular weight was 17,100, and the PDMS content was 1.0% by weight.

### Production Example 3-8

[Production of PDMS Copolymer B5]

Flaky PC-PDMS copolymer B5 was obtained in the same manner as in Production Example 3-4 except that reactive PDMS-A was replaced with reactive PDMS-C in Production Example 3-4. The viscosity average molecular weight was 17,200, and the PDMS content was 1.0% by weight.

### Production Example 3-9

[Production of PC-PDMS Copolymer B6]

Flaky PC-PDMS copolymer B6 was obtained in the same manner as in Production Example 3-4 except that 168 g of p-n-dodecylphenol were replaced with 96 g of p-tert-butylphenol in Production Example 3-4. The viscosity average molecular weight was 17,000, and the PDMS content was 1.0% by weight.

### Production Example 3-10

[Production of PC-PDMS Copolymer B7]

Flaky PC-PDMS copolymer B7 was obtained in the same manner as in Production Example 3-4 except that 168 g of p-n-dodecylphenol were replaced with 141 g of p-nonylphenol. The viscosity average molecular weight was 17,000, and the PDMS content was 1.0% by weight.

### Production Example 3-11

[Production of PC-PDMS Copolymer B8]

Flaky PC-PDMS copolymer B8 was obtained in the same manner as in Production Example 3-4 except that 168 g of p-n-dodecylphenol were replaced with 168 g of p-nonylphenol having a branched structure (Trade name; PDDP, Produced by YUKA SCHENECTADY Co., Ltd). The viscosity average molecular weight was 17,100, and the PDMS content was 1.0% by weight.

### Production Example 3-12

[Production of PC-PDMS Copolymer B9]

Flaky PC-PDMS copolymer B9 was obtained in the same manner as in Production Example 3-4 except that 46 g of reactive PDMS-A were replaced with 91 g of reactive PDMS-B and 168 g of p-n-dodecylphenol were replaced with 168 g of p-nonylphenol having abranched structure (Trade name; PDDP, Produced by YUKA SCHENECTADY Co., Ltd.) in Production Example 3-4. The viscosity average molecular weight was 16,900, and the PDMS content was 2.0% by weight.

### Production Example 4-1

[Production of BPA-PMDC Copolymer B1]

A sodium hydroxide aqueous solution of decanedicarboxylic acid (317 g of decanedicarboxylic acid, 110 g of sodium hydroxide and 2 liters of water) and 5.8 milliliters of triethylamine were added to 10 liters of PC oligomer obtained in Production Example 1. The mixture was reacted at 300 rpm and room temperature for 1 hour while being stirred. Subsequently, the system was mixed with a sodium hydroxide aqueous solution of bisphenol A (534 g of bisphenol A, 312 g of sodium hydroxide and 5 liters of water) and 136 g of p-cumylphenol. Further, 8 liters of methylene chloride were added thereto, and the resulting mixture was reacted at 500 rpm for 1 hour while being stirred. After the completion of the reaction, 7 liters of methylene chloride and 5 liters of water were added thereto, and the mixture was stirred at 500 rpm for 10 minutes. After the stirring was stopped, the reaction mixture was allowed to stand still, and separated into an organic phase and an aqueous phase. The resulting organic phase was alkali-washed with 5 liters of a 0.03 N sodium hydroxide aqueous solution, acid-washed with 5 liters of 0.2 N hydrochloric acid, and water-washed twice with 5 liters of water. Finally, methylene chloride was removed to obtain a flaky polymer. The viscosity average molecular weight was 17,000, and the content of decanedicarboxylic acid based on the overall monomer was 5.2 mols.

The viscosity average molecular weight was measured as described above.

The content of decanedicarboxylic acid was measured by ¹³C-NMR at room temperature using chloroform as a solvent. At this time, the content of decanedicarboxylic acid was defined by A/(A+B)×100 wherein A is an intensity of the peak (34.7 ppm) of the methyl group adjacent to the carboxyl residue of decanedicarboxylic acid and B is an intensity of the peak (30.7 ppm) of the methyl group of the isopropylidene group (derived from bisphenol A).

### Production Example 4-2

[Production of BPA-PMDC Copolymer B2]

Lexane SP 1010 supplied by General Electric was used as commercial BPA-PMDC copolymer. A comonomer was decanedicarboxylic acid, and an end capping agent was p-cumylphenol. The viscosity average molecular weight was 18,800, and the content of decanedicarboxylic acid based on the overall monomer was 8.2 mols.

### Production Example 4-3

[Production of Terminal-Modified Polycarbonate B1]

A 50-liter container equipped with a stirrer was charged with 10 liters of PC oligomer obtained in Production Example 1, and 162 g of p-n-dodecylphenol were dissolved therein. Subsequently, a sodium hydroxide aqueous solution (53 g of sodium hydroxide and 1 liter of water) and 5.8 cc of triethylamine were added thereto, and the mixture was reacted at 300 rpm for 1 hour while being stirred. Then, this system was mixed with a sodium hydroxide aqueous solution of bisphenol A (720 g of bisphenol A, 412 g of sodium hydroxide and 5.5 liters of water), and 8 liters of methylene chloride were added thereto. The mixture was reacted at 500 rpm for 1 hour while being stirred. After the completion of the reaction, 7 liters of methylene chloride and 5 liters of water were added thereto, and the resulting mixture was stirred at 500 rpm for 10 minutes. After the stirring was stopped, the reaction mixture was allowed to stand still, and separated into an organic phase and an aqueous phase. The organic phase obtained was washed with 5 liters of an alkali (0.03 N NaOH), with 5 liters of an acid (0.2 N hydrochloric acid) and with 5 liters of water (twice) in this order. Thereafter, methylene chloride was evaporated to obtain a flaky polymer. The viscosity average molecular weight was 17,500. The viscosity average molecular weight was measured as described above.

### Production Example 4-4

[Production of Terminal-Modified Polycarbonate B2]

A flaky polymer was obtained in the same manner as in Production Example 4-3 except that 162 g of p-n-dodecylphenol were replaced with 136 g of p-nonylphenol in Production Example 4-3. The viscosity average molecular weight was 17,400.

### Production Example 4-5

[Production of Terminal-Modified Polycarbonate B3]

A flaky polymer was obtained in the same manner as in Production Example 4-3 except that 162 g of p-n-dodecylphenol were replaced with 161 g of branched p-nonylphenol (Trade name; PDDP, Produced by YUKA SCHENECTADY Co., Ltd.) in Production Example 4-3. The viscosity average molecular weight was 17,500.

### Examples 1 to 4 and Comparative Examples 1 to 4

Each of PC-PDMS copolymers A1 to A3 obtained in the above-mentioned Production Examples, each of BPA-PMDC copolymers B1 and B2 obtained in the above-mentioned Production Examples, a commercial polycarbonate and PTFE were blended in amounts shown in Table 1. The mixture was kneaded at a temperature of 2830° C. using a vented twin-screw extruder (“TEM-35B” supplied by Toshiba Machine Co., Ltd.), and pelletized. As a commercial polycarbonate, Toughlon FN 1700A (viscosity average molecular weight: 17,200) and Toughlon FN 1500 (viscosity average molecular weight: 15,000) supplied by Idemitsu Petrochemical Co., Ltd. were used. As PTFE, Argoflon FS supplied by Montefluos was used.

Incidentally, in Example 1 and Comparative Example 1, PEP 36 [bis(2,6-di-tert-butyl-4-methylphenyl)pentaerythritol diphosphite] supplied by Asahi Denka Kogyo K.K. was added in an amount of 0.05 parts by weight as an antioxidant.

The pellets obtained were dried with hot air at 120° C. for 5 hours, and then molded into test pieces for measurement at a molding temperature of 280° C. and a mold temperature of 80° C. using IS100EN (injection molding machine) supplied by Toshiba Machine Co., Ltd. These test pieces were measured for a combustibility, an Izod impact strength and a spiral flow length (SFL) by the following methods. The results are shown in Table 2.

(1) Combustibility

UL94 standard. Thickness of 1.5 mm. A vertical combustion test was conducted according to Underwriters Laboratory Subject 94.

(2) Izod Impact Strength

Measured according to JIS K 7110. Five test pieces were tested, and the average value was shown.

(3) SFL

Measured under conditions that an injection pressure was 80 kg/m², a molding temperature 280° C., a mold temperature 80° C. and a thickness 2 mm.

TABLE 1

| | | | |
|---|---|---|---|
| PC-PDMS | BPA-PMDC | | |
| copolymer | copolymer | Polycar- | Amount of |

| | | Amount | | Amount | bonate | | polymethyl- | PTFE |
|---|---|---|---|---|---|---|---|---|
| | | (parts | | (parts | Amount | Polyorgano- | enedicar- | Amount |
| | | by | | by | (parts by | siloxane | boxylic | (parts by |
| | Type | weight) | Type | weight) | weight) | content*¹ | acid*² | weight) |
| Example 1 | A1 | 33 | B1 | 67 | 0 | 1.0 | 3.5 | 0.3 |
| Example 2 | A1 | 33 | B2 | 67 | 0 | 1.0 | 5.5 | 0.3 |
| Example 3 | A2 | 50 | B2 | 50 | 0 | 1.0 | 4.1 | 0.3 |
| Example 4 | A3 | 33 | B2 | 67 | 0 | 1.0 | 5.5 | 0.3 |
| Comparative | A1 | 33 | — | 0 | 67*³ | 1.0 | — | 0.3 |
| Example 1 | | | | | | | | |
| Comparative | A2 | 50 | — | 0 | 50*³ | 1.0 | — | 0.3 |
| Example 2 | | | | | | | | |
| Comparative | A3 | 33 | — | 0 | 67*³ | 1.0 | — | 0.3 |
| Example 3 | | | | | | | | |
| Comparative | A1 | 33 | — | 0 | 67*⁴ | 1.0 | — | 0.3 |
| Example 4 | | | | | | | | |

(Notes)
*¹Proportion (% by weight) of polyorganosiloxane based on the overall polycarbonate resin
*²Proportion (mol %) of a unit derived from polymethylenedicarboxylic acid based on the sum of a unit derived from bisphenol A and a unit derived form polymethylenedicarboxylic acid in the overall polycarbonate resin.
*³Toughlon FN 1700A
*⁴Toughion FN 1500

TABLE 2

| | | Combusti- | Izod impact |
|---|---|---|---|
| | SFL (cm) | bility | strength (KJ/m²) |
| Example 1 | 31 | V-0 | 70 |
| Example 2 | 32 | V-0 | 74 |
| Example 3 | 30 | V-0 | 73 |
| Example 4 | 32 | V-0 | 74 |
| Comparative | 24 | V-0 | 68 |
| Example 1 | | | |
| Comparative | 22 | V-0 | 67 |
| Example 2 | | | |
| Comparative | 24 | V-0 | 69 |
| Example 3 | | | |
| Comparative | 29 | V-2 | 45 |
| Example 4 | | | |

From Table 2, it becomes apparent that Examples are superior to Comparative Examples in fluidity and impact resistance.

### Examples 5 to 11 and Comparative Examples 5 and 6

Each of PC-PDMS copolymers B1 to B9 obtained in the above-mentioned Production Examples was blended with PTFE in amounts shown in Table 3. The mixture was kneaded at a temperature of 280° C. using a vented twin-screw extruder (TEM-35B supplied by Toshiba Machine Co., Ltd.), and pelletized. As a commercial polycarbonate, Toughlon FN 1700A (viscosity average molecular weight: 17,200) supplied by Idemitsu Petrochemical Co., Ltd. were used. As PTFE, Argoflon F5 supplied by Montefluos was used.

Incidentally, in Example 5, 10 and Comparative Example 5, PEP 36 [bis(2,6-di-tert-butyl-4-methylphenyl)pentaerythritol diphosphite] supplied by Asahi Denka Kogyo K.K. was added in an amount of 0.05 parts by weight as an antioxidant.

The pellets obtained were dried with hot air at 120° C. for 5 hours, and then molded into test pieces for measurement at a molding temperature of 280° C. and a mold temperature of 80° C. using IS100EN (injection molding machine) supplied by Toshiba Machine Co., Ltd. These test pieces were measured for a combustibility, an Izod impact strength and a spiral flow length (SFL) by the following methods. The results are shown in Table 4.

TABLE 3

| | PC-PDMS | | Polycar- | | |
|---|---|---|---|---|---|
| | copolymer | | bonate | | PTFE |
| | | Amount | Amount | | Amount |
| | | (parts by | (parts by | PDMS | (parts by |
| | Type | weight) | weight) | content*¹ | weight) |
| Example 5 | B1 | 100 | 0 | 1.0 | 0.3 |
| Example 6 | B2 | 50 | 50 | 1.0 | 0.3 |
| Example 7 | B3 | 33 | 67 | 1.0 | 0.3 |
| Example 8 | B4 | 100 | 0 | 1.0 | 0.3 |
| Example 9 | B5 | 100 | 0 | 1.0 | 0.3 |
| Example 10 | B8 | 100 | 0 | 1.0 | 0.3 |
| Example 11 | B9 | 50 | 50 | 1.0 | 0.3 |
| Comparative | B6 | 100 | 0 | 1.0 | 0.3 |
| Example 5 | | | | | |
| Comparative | B7 | 100 | 0 | 1.0 | 0.3 |
| Example 6 | | | | | |

(Note)
*¹Proportion (% by weight) of PDMS based on the overall polycarbonate resin

TABLE 4

| | | Combusti- | Izod impact |
|---|---|---|---|
| | SFL (cm) | bility | strength (KJ/m²) |
| Example 5 | 34 | V-0 | 74 |
| Example 6 | 31 | V-0 | 71 |
| Example 7 | 29 | V-0 | 70 |
| Example 8 | 34 | V-0 | 74 |
| Example 9 | 33 | V-0 | 74 |
| Example 10 | 31 | V-0 | 72 |
| Example 11 | 28 | V-0 | 75 |
| Comparative | 24 | V-0 | 67 |
| Example 5 | | | |
| Comparative | 26 | V-0 | 67 |
| Example 6 | | | |

From Table 4, it becomes apparent that Examples are superior to Comparative Examples in fluidity and impact resistance.

### Examples 12 to 17 and Comparative Examples 7 to 10

Each of PC-PDMS copolymers A1 to A3 obtained in the above-mentioned Production Examples, each of terminal-modified polycarbonates B1 to B3 obtained in the above-mentioned Production Examples, a commercial polycarbonate and PTFE were blended in amounts shown in Table 5. The mixture was kneaded at a temperature of 280° C. using a vented twin-screw extruder (TEM-35B supplied by Toshiba Machine Co., Ltd.), and pelletized. As a commercial polycarbonate, Toughlon FN 1700A (viscosity average molecular weight: 17,200) supplied by Idemitsu Petrochemical Co., Ltd. was used. As PTFE, Argoflon F5 supplied by Montefluos was used.

Incidentally, in Example 12, 15 and Comparative Example 7, PEP 36 [bis(2,6-di-tert-butyl-4-methylphenyl)pentaerythritol diphosphite] supplied by Asahi Denka Kogyo K.K. was added in an amount of 0.05 parts by weight as an antioxidant.

The pellets obtained were dried with hot air at 120° C. for 5 hours, and then molded into test pieces at a molding temperature of 280° C. and a mold temperature of 80° C. using IS 100 EN (injection-molding machine) supplied by Toshiba Machine Co., Ltd. The test pieces were measured for a combustibility, an Izod impact strength and a spiral flow length (SFL) as described above. The results are shown in Table 6.

TABLE 5

| | | | |
|---|---|---|---|
| PC-PDMS | Terminal- | Polycar- | |
| copolymer | modified PC | bonate | PTFE |

| | | Amount | | Amount | Amount | | Amount |
|---|---|---|---|---|---|---|---|
| | | (parts by | | (parts by | (parts by | PDMS | (parts by |
| | Type | weight) | Type | weight) | weight) | content*¹ | weight) |
| Example 12 | A1 | 33 | B1 | 67 | 0 | 1.0 | 0.3 |
| Example 13 | A2 | 50 | B1 | 50 | 0 | 1.0 | 0.3 |
| Example 14 | A3 | 33 | B1 | 67 | 0 | 1.0 | 0.3 |
| Example 15 | A1 | 33 | B3 | 67 | 0 | 1.0 | 0.3 |
| Example 16 | A2 | 50 | B3 | 50 | 0 | 1.0 | 0.3 |
| Example 17 | A3 | 33 | B3 | 67 | 0 | 1.0 | 0.3 |
| Comparative | A1 | 33 | — | 0 | 67 | 1.0 | 0.3 |
| Example 7 | | | | | | | |
| Comparative | A2 | 50 | — | 0 | 50 | 1.0 | 0.3 |
| Example 8 | | | | | | | |
| Comparative | A3 | 33 | — | 0 | 67 | 1.0 | 0.3 |
| Example 9 | | | | | | | |
| Comparative | A1 | 33 | B2 | 67 | 0 | 1.0 | 0.3 |
| Example 10 | | | | | | | |

(Note)
*¹Proportion (% by weight) of polyorganosiloxane based on the overall polycarbonate resin.

TABLE 6

| | | Combusti- | Izod impact |
|---|---|---|---|
| | SFL (cm) | bility | strength (KJ/m²) |
| Example 12 | 32 | V-0 | 70 |
| Example 13 | 30 | V-0 | 74 |
| Example 14 | 32 | V-0 | 73 |
| Example 15 | 29 | V-0 | 72 |
| Example 16 | 28 | V-0 | 75 |
| Example 17 | 29 | V-0 | 74 |
| Comparative | 24 | V-0 | 68 |
| Example 7 | | | |
| Comparative | 22 | V-0 | 67 |
| Example 8 | | | |
| Comparative | 24 | V-0 | 69 |
| Example 9 | | | |
| Comparative | 26 | V-0 | 69 |
| Example 10 | | | |

From Table 6, it becomes apparent that Examples are superior to Comparative Examples in fluidity and impact resistance.

According to the invention, a polycarbonate resin composition excellent in fluidity, impact resistance and flame retardance can be provided. Consequently, the resin composition obtained by the invention is preferably used in, for example, the fields of an office automation equipment and electrical and electronic appliances.

What is claimed is:

1. A polycarbonate resin composition wherein 100 parts by weight of an aromatic polycarbonate resin containing (A-1) an aromatic polycarbonate-polyorganosiloxane copolymer and (B-1) a copolyester carbonate having an aliphatic segment are blended with from 0.05 to 1 part by weight of polytetrafluoroethylene having a number average molecular weight of at least 500,000 and having a fibril formability.

2. The polycarbonate resin composition as claimed in claim 1, wherein the viscosity average molecular weight of the overall aromatic polycarbonate resin containing (A-1) component and (B-1) component is between 10,000 and 40,000.

3. The polycarbonate resin composition as claimed in claim 1 or 2, wherein the proportion of the polyorganosiloxane in (A-1) component is between 0.1 and 2.0% by weight based on the overall aromatic polycarbonate resin containing (A-1) component and (B-1) component.

4. The polycarbonate resin composition as claimed in claim 1 or 2, wherein the aliphatic segment in (B-1) component is derived from polymethylenedicarboxylic acid, and the proportion of the unit derived from said polymethylenedicarboxylic acid is between 1 and 15 mol % based on the sum of the unit derived from the main monomer (dihydric phenol) and the unit derived from said polymethylenedicarboxylic acid in the overall aromatic polycarbonate resin containing (A-1) component and (B-1) component.

5. The polycarbonate resin composition as claimed in claim 3, wherein the aliphatic segment in (B-1) component is derived from polymethylenedicarboxylic acid, and the proportion of the unit derived from said polymethylenedicarboxylic acid is between 1 and 15 mol % based on the sum of the unit derived from the main monomer (dihydric phenol) and the unit derived from said polymethylenedicarboxylic acid in the overall aromatic polycarbonate resin containing (A-1) component and (B-1) component.

6. A housing of an office automation equipment obtained by using the polycarbonate resin composition as claimed in claim 1 or 2.

7. A polycarbonate resin composition wherein 100 parts by weight of an aromatic polycarbonate resin containing (A-2) an aromatic polycarbonate-polyorganosiloxane copolymer having a terminal group represented by formula (1) 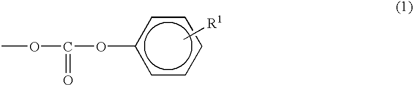
wherein
R¹ represents an alkyl group having from 10 to 20 carbon atoms are blended with (C) from 0.05 to 1 part by weight of polytetrafluoroethylene having a number average molecular weight of at least 500,000 and having a fibril formability.

8. The polycarbonate resin composition as claimed in claim 7, wherein the viscosity average molecular weight of the overall aromatic polycarbonate resin containing (A-2) component is between 10,000 and 40,000.

9. The polycarbonate resin composition as claimed in claim 7 or 8, wherein the proportion of the polyorganosiloxane in (A-2) component is between 0.1 and 2.0% by weight based on the overall aromatic polycarbonate resin containing (A-2) component.

10. The polycarbonate resin composition as claimed in claim 7 or 8, wherein R¹ in formula (1) represents a branched alkyl group having from 10 to 20 carbon atoms.

11. A housing of an office automation equipment obtained by using the polycarbonate resin composition as claimed in claim 7 or 8.

12. A polycarbonate resin composition wherein 100 parts by weight of an aromatic polycarbonate resin containing (A-3) an aromatic polycarbonate-polyorganosiloxane copolymer having a terminal group represented by formula (2) 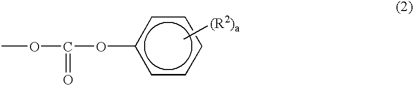
wherein
R² represents an alkyl group having from 1 to 9 carbon atoms, an aryl group having from 6 to 20 carbon atoms or a halogen atom, and
a is an integer of from 0 to 5
and (B-2) an aromatic polycarbonate having a terminal group represented by formula (1) 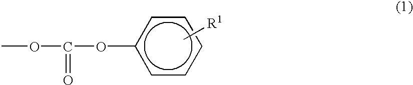
wherein
R¹ represents an alkyl group having from 10 to 20 carbon atoms
are blended with (C) from 0.05 to 1 part by weight of polytetrafluoroethylene having a number average molecular weight of at least 500,000 and having a fibril formability.

13. The polycarbonate resin composition as claimed in claim 12, wherein the viscosity average molecular weight of the overall aromatic polycarbonate resin containing (A-3) component and (B-2) component is between 10,000 and 40,000.

14. The polycarbonate resin composition as claimed in claim 12 or 13, wherein the proportion of the polyorganosiloxane in component (A-3) is between 0.1 and 2.0% by weight based on the overall aromatic polycarbonate resin containing (A-3) component and (B-2) component.

15. The polycarbonate resin composition as claimed in claim 12 or 13, wherein the proportion of (B-2) component is at least 10% by weight based on the overall aromatic polycarbonate resin containing (A-3) component and (B-2) component.

16. The polycarbonate resin composition as claimed in claim 12 or 13, wherein R¹ in formula (1) represents a branched alkyl group having from 10 to 20 carbon atoms.

17. The polycarbonate resin composition as claimed in claim 14, wherein the proportion of (B-2) component is at least 10% by weight based on the overall aromatic polycarbonate resin containing (A-3) component and (B-2) component.

18. A housing of an office automation equipment formed by using the polycarbonate resin composition as claimed in claim 12 or 13.
